(19) United States
(12) Patent Application Publication
(10) Pub. No.: US 2010/0145905 A1
(43) Pub. Date: Jun. 10, 2010

(54) SYSTEM AND METHOD FOR ACQUIRING AND MANAGING DATA

(76) Inventor: Guy Sam Sepielli, North Fort Myers, FL (US)

Correspondence Address: FRASER CLEMENS MARTIN & MILLER LLC, 28366 KENSINGTON LANE, PERRYSBURG, OH, 43551, US

(21) Appl. No.: 12/635,389

(22) Filed: Dec. 10, 2009

Related U.S. Application Data
(60) Provisional application No. 61/121,205, filed on Dec. 10, 2008.

(51) Int. Cl. G06F 17/30; G06F 12/00

(52) U.S. Cl. 707/609; 707/740; 707/E17.005

(57) ABSTRACT

A data acquisition and management system is disclosed, the system including a database for receiving, cataloging, and storing data and information, a vendor interface device for transmitting a plurality of condition report requests to the database, an administrator interface device for viewing the transmitted condition report requests and assigning each of the condition report requests to a particular filed agent, and an agent interface device for viewing the assigned condition report requests, acquiring a condition data in response to the condition report requests, and transmitting the condition data to the database, wherein the condition data represents a property.

### CROSS-REFERENCE TO RELATED APPLICATION

This application claims the benefit of U.S. Provisional Patent Application No. 61/121,205 filed on Dec. 10, 2008.

### FIELD OF THE INVENTION

The invention relates to data acquisition and management. More particularly, the invention is directed to a system and a method for acquiring and managing data representing characteristics of real and personal property.

### BACKGROUND OF THE INVENTION

Real estate transactions typically involve many participants, including buyers, sellers, agents, brokers, developers, property owners, inspectors, escrow agents, loan officers, and the like. Each participant typically maintains various information about the properties for which the participant is involved in a transaction or potential transaction. Often, each participant maintains a separate physical or electronic file. The individual files of the participants may or may not share common information. Nevertheless, even if all participants have accurate information, the maintenance of separate files results in duplicated effort, as each participant generates and records the same information about a property. Furthermore, while it is possible to share real estate information through computer networks, conventional computer networks have not offered security features that are tailored to the individual needs and roles of participants in real estate transactions.

The current real estate industry trend is toward a more global real estate market featuring large regional and national providers. This has led to a mass consolidation among the smaller local and regional brokers in which local brokers are being replaced by national real estate companies. On a national or international scale, the real estate industry is so large and national or international scale, the real estate industry is so large and fragmented that there exists very limited research data. In view of the industry trend toward larger brokers, there exists a need for more accurate national real estate data. Parties in the real estate industry that require extensive information include sales/leasing brokers, property owners/managers, construction firms, real estate developers, banks, investors, asset managers, government agencies, security issuers, appraisers and insurers.

An efficient contemporary real estate related business requires accurate and comprehensive research capabilities as well as real-time access to relevant information. The Internet is a mass communications and commerce medium enabling millions of people worldwide to share information and conduct business electronically. The Internet and related technologies permit easy access to increasingly greater volumes of real-time information at low cost without geographic limitation.

It would be desirable to develop a system and a method for acquiring and managing data, wherein the system and method provides real-time access to a centralized database including acquired data and information having at least one of a time stamp, a date stamp, and a global positioning of an on-site location where the data is acquired.

### SUMMARY OF THE INVENTION

Concordant and consistent with the present invention, a system and method for acquiring and managing data, wherein the system and method provides real-time access to a centralized database including acquired data and information having a time stamp, a date stamp, and a global positioning of an on-site location where the data is acquired, has surprisingly been discovered.

In one embodiment, a data acquisition and management system comprises: a database for receiving, cataloging, and storing data; a vendor interface device in data communication with the database for transmitting a condition report request thereto; an administrator interface device in data communication with the database for viewing the transmitted condition report request and assigning the condition report request to a particular field agent; and an agent interface device in data communication with the database for viewing the assigned condition report request, acquiring a condition data in response to the condition report request, and transmitting the condition data to the database, wherein the condition data represents a property.

In another embodiment, a data acquisition and management system comprises: a database for receiving, cataloging, and storing data; a vendor interface device in data communication with the database for transmitting a condition report request thereto; an administrator interface device in data communication with the database for viewing the transmitted condition report request and assigning the condition report request to a particular field agent; and an agent interface device in data communication with the database for viewing the assigned condition report request, acquiring a condition data in response to the condition report request, and transmitting the condition data to the database, wherein the condition data includes at least one of a digital photograph, a text description, a video, a time stamp, a date stamp, and a global position.

The invention also provides methods for acquiring and managing data.

One method comprises the steps of: providing a database for receiving, cataloging and storing data and information; transmitting a condition report request to the database; acquiring a condition data in response to the condition report request, wherein the condition data includes at least one of a digital photograph, a text description, a video, a time stamp, a date stamp, and a global position; and transmitting the condition data to the database.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a data acquisition and management system according to an embodiment of the present invention; and

FIG. 2 is a schematic block diagram showing an operation of the system of FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

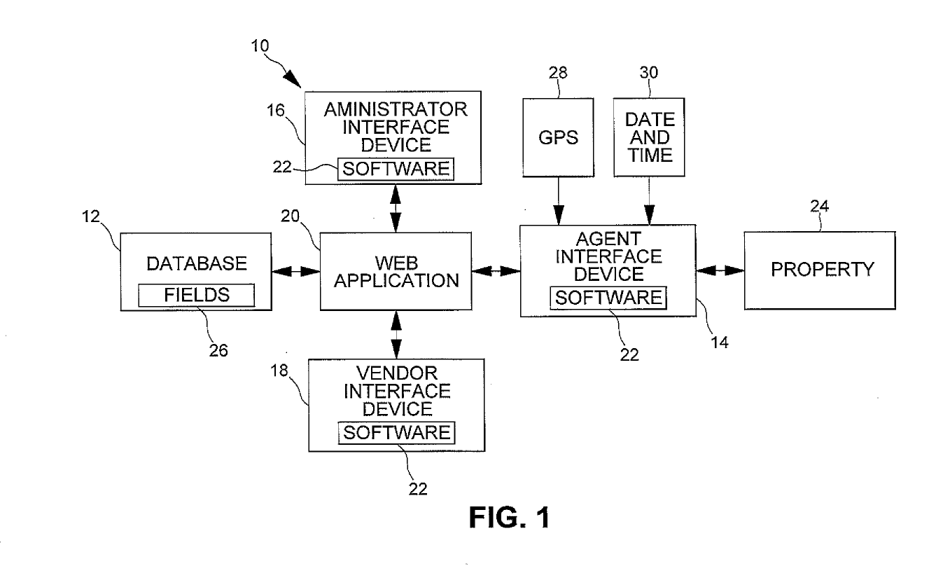

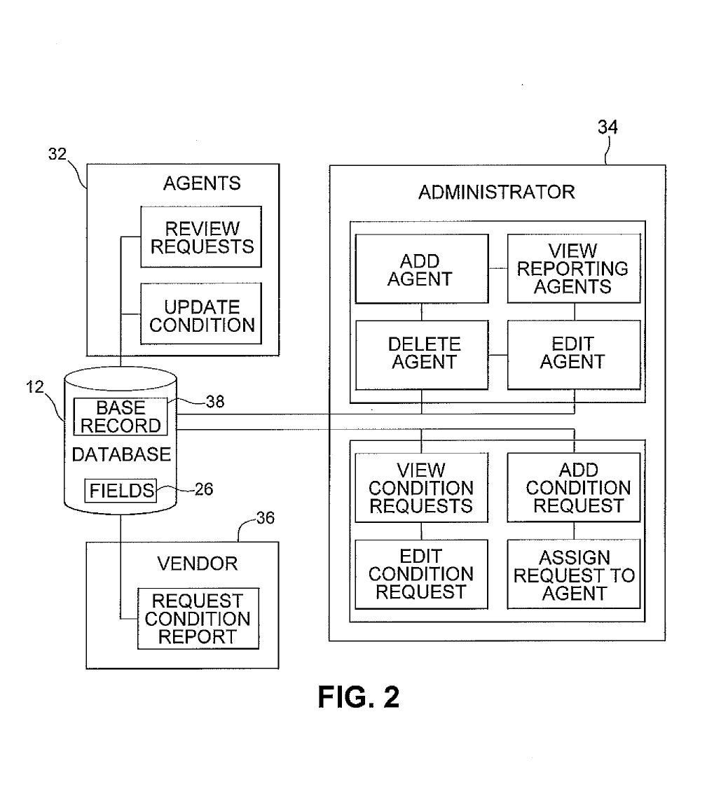

FIGS. 1 and 2 illustrate a data acquisition and management system 10 according to an embodiment of the present invention. As shown, the data acquisition and management system 10 includes a database 12, an agent interface device 14, an administrator interface device 16, and a vendor interface device 18. As such, each of the interface devices 14, 16, 18 are adapted to intercommunicate with the database 12 for sending and receiving data and information therebetween. The interface devices 14, 16, 18 may communicate by means of a wireless network such as 3g and 4g, for example. In certain embodiments, a web application 20 hosted on a server provides a means for each of the interface devices 14, 16, 18 to intercommunicate with the database 12 and each other. In other embodiments, each of the interfaces devices 14, 16, 18 includes a software program 22 for unifying the data intercommunication between each of the interface devices 14, 16, 18 and the database 12. As such, each of the interface devices 14, 16, 18 have a standardized interface for viewing and inputting data. However, each of the interface devices 14, 16, 18 may have a varying level of access to certain elements of the software program 22. Other means of intercommunication may be used such as a phone application, as desired. It is understood that any number of interface devices 14, 16, 18 may be used, as desired. It is further understood that the interface devices 14, 16, 18 may be adapted to intercommunicate with other applications similar to Google™ maps, Bing™ Maps, and Yahoo!® maps to acquire position and map information, for example.

The database 12 is adapted to receive, catalog, and store a condition data relating to a property 24. In certain embodiments, the condition data includes real estate data such as digital photographs, text descriptions, time and date stamps, and a global position, for example. However, other data may be included such as automotive and maritime equipment data. It is understood that the condition data may be cataloged based upon a plurality of record keeping fields 26. As a non-limiting example, the record keeping fields 26 may be pre-determined or defined and modified through at least one of the interface devices 14, 16, 18. It is further understood that the record keeping fields 26 may be defined by customary fields used in a particular domain such as real estate, for example. However, the record keeping fields 26 may be defined by existing software having pre-defined fields and/or other domains and industries such as the insurance industry, for example.

The agent interface device 14 provides a means for acquiring the condition data and transmitting the condition data to the database 12. Specifically, the agent interface device 14 is adapted to capture digital photographs, determine a global position, and transmit the digital photographs along with a text description. As a non-limiting example, the agent interface device 14 is a mobile device such as a cellular phone, a PDA, an iphone manufactured by Apple, Inc., a device manufactured by Blackberry and a personal computer. However, other devices and system for capturing and transmitting digital photographs along with a text description may be used, as desired. As shown, the agent interface device 14 is associated with a Global Positioning System (GPS) 28 and a date and time device 30 for associating a time and/or a date with the transmitted condition data.

In certain embodiments, the agent interface device 14 is associated with a particular field agent 32, reporting agent, or user, wherein the field agent 32 acquires the condition data from an on-site location. As a non-limiting example, the on-site location may be a real estate lot associated with a foreclosed home. As shown, the field agent 32 acquires condition data relating to the pre-determined property 24. It is understood that the property 24 may be real property or personal property.

The administrator interface device 16 provides a means for administrative control functions such as managing the condition data stored in the database 12, managing any number of the field agents 32 and associated agent interface devices 14, and managing a plurality of vender condition report requests. As a non-limiting example, the administrator interface device 16 is a mobile device such as a cellular phone, a FDA, an iphone manufactured by Apple, Inc., a device manufactured by Blackberry and a personal computer. However, other interface devices such as a network of desktop computers may be used, for example. In certain embodiments, an administrator 34 may use the administrator interface device 16 to view any number of condition report requests, add requests, edit requests, and assign a particular request to a dedicated field agent. Additionally, the administrator 34 may view a list of the field agents 32, add field agents 32, delete field agents 32, and edit information relating to the field agents 32.

The vendor interface device 18 provides a means for transmitting the condition report requests to the database 12. As a non-limiting example, the vendor interface device 18 is a mobile device such as a cellular phone, a PDA, an iphone manufactured by Apple, Inc., a device manufactured by Blackberry and a personal computer. However, other interface devices such as a network of desktop computers may be used, for example. In certain embodiments, a vendor 36 may access the web application 20 to submit a condition report request for the property 24, wherein the condition report request defines the property 24 to be researched for acquiring the condition data. It is understood that the condition report request may have pre-determined fields associated with the record keeping fields 26 of the database 12 to expedite the request process of the vendor 36. It is further understood that the condition report request may be associated with the particular vendor 36 based upon an identification and pre-determined cataloging system.

As more clearly shown in FIG. 2 an operation of the data acquisition and management system 10 is illustrated. As shown, a condition report is requested by the vendor 36 for the property 24. It is understood that a request for the condition report may be made for any person, place, or thing. It is further understood that the administrator 34 can add and/or edit a condition report.

Once the condition report request is created or received, the administrator 34 can view the condition report request and inputs a base record 38 into the database 12, wherein the base record 38 is associated with the condition report request. As a non-limiting example, the base record 38 includes information for identifying the vendor 36 for future management of vendor-specific data. It is understood that information in the base record 38 may include any data or information inputted by the administrator 34. In certain embodiments, the base record 38 may be inputted via the web application 20. However, other applications, such the embedded software 22 and phone-based applications may be used.

Once the condition report request is cataloged in the database 12, the administrator 34 assigns the particular condition report request to the dedicated field agent 32 or reporting agent. Thereafter, the field agent 32 logs into the database 12 to view all of the condition report requests assigned to the particular field agent 32. Once a condition report request is received, the field agent 32 travels to an on-site location defined by the condition report request and acquires the requested data and information including the condition data It is understood that the process for reporting can vary based on each application and may include taking photographs and video. It is further understood that the field agent 32 may acquire condition data related to any property, regardless of the condition report request. In certain embodiments, the condition data is acquired via the agent interface device 14, wherein the agent interface device 14 is capable of accessing the Internet and recording at least a GPS coordinates, a time, and a date. Once the data acquisition is completed, the condition data is transmitted to the database 12. As a non-limiting example, the condition data is transmitted wirelessly or over the Internet. As such, the requesting vendor 36 may log into the database 12 to view the completed condition reports.

The data acquisition and management system 10 and the method for acquiring and managing data provide real-time access to a centralized collection of data and information. The data and information are acquired by on-site field agents 32, thereby providing updated information related to the property 24 from a remote location. The vendors 36 such as sales/leasing brokers, property owners/managers, construction firms, real estate developers, banks, investors, asset managers, government agencies, security issuers, appraisers, and insurers may request a condition report for any property. Accordingly, the field agent 32 acquires the related data and information and uploads the condition report to the centralized database 12, wherein the vendor may view the requested condition report from any location.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A data acquisition and management system comprising:
a database for receiving, cataloging, and storing data;
a vendor interface device in data communication with the database for transmitting a condition report request thereto;
an administrator interface device in data communication with the database for viewing the transmitted condition report request and assigning the condition report request to a particular field agent; and
an agent interface device in data communication with the database for viewing the assigned condition report request, acquiring a condition data in response to the condition report request, and transmitting the condition data to the database, wherein the condition data represents a property.

2. The data acquisition and management system according to claim 1, wherein at least one of the vendor interface device, the administrator interface device, and the agent interface device communicates with the database via a wireless network.

3. The data acquisition and management system according to claim 1, wherein at least one of the vendor interface device, the administrator interface device, and the agent interface device communicates with the database via the Internet.

4. The data acquisition and management system according to claim 3, wherein each of the vendor interface device, the administrator interface device, and the agent interface device intercommunicate with the database through a web application.

5. The data acquisition and management system according to claim 1, wherein each of the vendor interface device, the administrator interface device, and the agent interface device includes a software program for unifying the data intercommunication between each of the vendor interface device, the administrator interface device, and the agent interface device and the database.

6. The data acquisition and management system according to claim 1, wherein the agent interface device is a mobile device capable of capturing and transmitting a digital photograph along with a text description.

7. The data acquisition and management system according to claim 1, wherein the agent interface device is associated with at least one of a associated with a global positioning system and a date and time device for associating at least one of a position, a time, and a date with the transmitted condition data.

8. The data acquisition and management system according to claim 1, wherein the database catalogs data based upon a plurality of pre-defined record keeping fields.

9. A data acquisition and management system comprising:
a database for receiving, cataloging, and storing data;
a vendor interface device in data communication with the database for transmitting a condition report request thereto;
an administrator interface device in data communication with the database for viewing the transmitted condition report request and assigning the condition report request to a particular field agent; and
an agent interface device in data communication with the database for viewing the assigned condition report request, acquiring a condition data in response to the condition report request, and transmitting the condition data to the database, wherein the condition data includes at least one of a digital photograph, a text description, a video, a time stamp, a date stamp, and a global position.

10. The data acquisition and management system according to claim 9, wherein at least one of the vendor interface device, the administrator interface device, and the agent interface device communicates with the database via a wireless network.

11. The data acquisition and management system according to claim 9, wherein at least one of the vendor interface device, the administrator interface device, and the agent interface device communicates with the database via the Internet.

12. The data acquisition and management system according to claim 11, wherein each of the vendor interface device, the administrator interface device, and the agent interface device intercommunicate with the database through a web application.

13. The data acquisition and management system according to claim 9, wherein each of the vendor interface device, the administrator interface device, and the agent interface device includes a software program for unifying the data intercommunication between each of the vendor interface device, the administrator interface device, and the agent interface device and the database.

14. The data acquisition and management system according to claim 9, wherein the agent interface device is a mobile device capable of capturing and transmitting a digital photograph along with a text description.

15. The data acquisition and management system according to claim 9, wherein the agent interface device is associated with at least one of a associated with a global positioning system and a date and time device for associating at least one of a position, a time, and a date with the transmitted condition data.

16. The data acquisition and management system according to claim 9, wherein the database catalogs data based upon a plurality of pre-defined record keeping fields.

17. A method for acquiring and managing data, the method comprising the steps of:
providing a database for receiving, cataloging, and storing data and information;
transmitting a condition report request to the database, wherein the condition report is related to a property;
acquiring a condition data in response to the condition report request, wherein the condition data includes at least one of a digital photograph, a text description, a video, a time stamp, a date stamp, and a global position; and
transmitting the condition data to the database.

18. The method according to claim 17, further comprising the step of inputting a base record into the database, wherein the base record is associated with the condition report request and includes information relating to a source of the condition report request.

19. The method according to claim 17, wherein the condition data is acquired by a field agent at an on-site location defined by the condition report request.

20. The method according to claim 17, wherein the condition data is transmitted to the database through a web application.
